(19) United States
(12) Patent Application Publication
(10) Pub. No.: US 2023/0256721 A1
(43) Pub. Date: Aug. 17, 2023

(54) MULTILAYER STRUCTURE HAVING A COHESIVE LAYER

(71) Applicant: Cryovac, LLC, Charlotte, NC (US)

(72) Inventor: Michael Andrew Lindler, Charlotte, NC (US)

(21) Appl. No.: 18/015,668

(22) PCT Filed: Jul. 12, 2021
(86) PCT No.: PCT/US2021/041234

§ 371 Date: Jan. 11, 2023

Related U.S. Application Data
(60) Provisional application No. 63/052,479, filed on Jul. 16, 2020.

(51) Int. Cl. B32B 27/08; B65D 75/58; B65D 65/40; B65D 35/00; B32B 27/36; B32B 27/32; B32B 7/12; B32B 37/12; B32B 37/18; B32B 27/18; B32B 27/30; B32B 7/06

(52) U.S. Cl. CPC B32B 27/08; B65D 75/5855; B65D 75/5866; B65D 65/40; B65D 35/00; B32B 27/36; B32B 27/32; B32B 7/12; B32B 37/12; B32B 37/182; B32B 27/18; B32B 27/306; B32B 7/06; B32B 27/308; B32B 2307/748; B32B 2439/02; B32B 2439/40; B32B 2270/00; B32B 2250/24; B32B 2250/03; B32B 2307/31; B32B 2439/70; B32B 2367/00; B32B 2323/04

(57) ABSTRACT

A cohesive sealant layer directly adhered to two adjacent layers. One adjacent layer comprising predominately polyester. The other adjacent layer comprising predominately polyethylene polymers. The cohesive sealant layer being a blend including polyester and at least a compatibilizer such that the cohesive sealant layer has an opening strength of between 0.4 and 3.4 lb-f/in or between 0.9 and 3.0 lb-f/in measured according to ASTM F88 with a crosshead speed of 10 inches per minute, using a 1-inch wide sample. The cohesive sealant layer having a bond strength to both of the adjacent layers which is greater than the opening strength resulting in in a continuous portion of the cohesive sealant layer remaining adhered to the two adjacent layers when subjected to a force greater than the opening strength.

### CROSS-REFERENCE TO RELATED APPLICATIONS

This application claims priority to U.S. Provisional Patent Application Ser. No. 63/052,479, filed Jul. 16, 2020 and entitled “Multilayer Structure Having A Cohesive Layer,” the entirety of which is incorporated herein by reference.

### BACKGROUND

The subject matter disclosed herein relates to multilayer film structure. More particularly, to a multilayer film structure having a cohesive layer that bonds to adjacent layers with a force greater than the force to cause cohesive failure within the cohesive layer.

The cohesive layer adheres to dissimilar layers without the need for an intervening tie layer. The adhesion of the cohesive layer to the dissimilar layers is stronger than the opening strength required to cause cohesive failure within the cohesive layer.

The discussion above is merely provided for general background information and is not intended to be used as an aid in determining the scope of the claimed subject matter.

### BRIEF DESCRIPTION

A cohesive sealant layer directly adhered to two adjacent layers. One adjacent layer comprising predominately polyester. The other adjacent layer comprising predominately polyethylene polymers. The cohesive sealant layer being a blend including polyester and at least a compatibilizer such that the cohesive sealant layer has an opening strength of between 0.4 and 3.4 lb-f/in or between 0.9 and 3.0 lb-f/in measured according to ASTM F88 with a crosshead speed of 10 inches per minute, using a 1-inch wide sample. The cohesive sealant layer having a bond strength to both of the adjacent layers which is greater than the opening strength resulting in in a continuous portion of the cohesive sealant layer remaining adhered to the two adjacent layers when subjected to a force greater than the opening strength

An advantage that may be realized in the practice of some disclosed embodiments of the cohesive sealant layer is that the cohesive failure can be achieved without an intra-layer failure within a structure.

In one exemplary embodiment, a multilayer package is disclosed. The multilayer package comprises a first layer comprising predominately polyester. The package further comprises a second layer comprising predominately polyethylene polymers. A cohesive sealant layer is directly adhered to the first and second layers. The sealant layer comprises between 35-65 wt % polyester; and between 5-65 wt % compatibilizer. The cohesive sealant layer has an opening strength of between 0.4 and 3.4 lb-f/in or between 0.9 and 3.0 lb-f/in measured according to ASTM F88 with a crosshead speed of 10 inches per minute, using a 1-inch wide sample and the cohesive sealant layer has a bond strength to both of the first and second layer which is greater than the opening strength resulting in in a continuous portion of the cohesive sealant layer remaining adhered to both the first layer and the second layer when subjected to a force greater than the opening strength.

In another exemplary embodiment, the multilayer structure comprises a flexible film comprising an inner layer comprising predominately polyethylene polymers. The structure includes a rigid or semi-rigid insert comprising a layer comprising predominately polyester. The structure further includes a cohesive sealant layer having two sides which are direct adhered to the inner layer of the flexible film on one side and direct adhered to the layer comprising predominately polyester of the rigid or semi-rigid insert on the other side. The cohesive sealant layer comprising between 25-65 wt % polyester; and between 5-65 wt % compatibilizer. The cohesive sealant layer has an opening strength of between 0.4 and 3.4 lb-f/in or between 0.9 and 3.0 lb-f/in measured according to ASTM F88 with a crosshead speed of 10 inches per minute, using a 1-inch wide sample and the cohesive sealant layer has a bond strength to both of the inner layer of the flexible film and the layer comprising predominately polyester of the rigid or semi-rigid insert which is greater than the opening strength resulting in in a continuous portion of the cohesive sealant layer remaining adhered to both the inner layer of the flexible film and the layer comprising predominately polyester of the rigid or semi-rigid insert when subjected to a force greater than the opening strength.

In another exemplary embodiment, a method of making a multilayer package is disclosed. The method comprises the steps of i) providing a first layer comprising predominately polyester ii) providing a second layer comprising predominately polyethylene polymers iii) providing a multilayer film comprising a cohesive sealant layer and one of the first layer or the second layer; and iv) heat sealing the cohesive sealant layer to the other of the first layer or the second layer that is not part of the multilayer film. The cohesive sealant layer comprises between 35-65 wt % polyester; and 5-65 wt % compatibilizer. The cohesive sealant layer has an opening strength of between 0.4 and 3.4 lb-f/in or between 0.9 and 3.0 lb-f/in measured according to ASTM F88 with a crosshead speed of 10 inches per minute, using a 1-inch wide sample and the cohesive sealant layer has a bond strength to both of the first and second layer which is greater than the opening strength resulting in in a continuous portion of the cohesive sealant layer remaining adhered to both the first layer and the second layer when subjected to a force greater than the opening strength.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIGS. 1A-1C depict an exemplary embodiment of a pouch with a product disposed therein and a series of instances of a process of dispensing the product from the pouch;

FIG. 2 depicts an exemplary embodiment of a tray sealed with a film along the perimeter and a product disposed therein;

FIG. 3 is a cross sectional view of an insert disposed within a pouch in a sealed status according to some embodiments;

FIG. 4 is a cross sectional view of an insert disposed within a pouch with the cohesive sealant layer separated according to some embodiments;

FIG. 5 is a cross section view of tray depicted in FIG. 2 as the lid material is being removed;

FIGS. 6A-6E depict a process of dispensing product (not shown) from a pouch according to some embodiments;

FIG. 7 is an exploded view of a pouch design having an insert and cohesive sealant layer according to some embodiments; and

FIGS. 8A and 8B depict front and side views, respectively, of a pouch in accordance with an embodiment.

### DETAILED DESCRIPTION

As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

The multi-layer films described herein may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In an embodiment, the multilayer film utilizes microlayers. A microlayer section may include between 10 and 1,000 microlayers in each microlayer section.

The multi-layer films described herein include a cohesive layer that is directly adhered to a first layer on one side and second layer on the other side. The first and second layers being dissimilar compositions. The cohesive layer bonds to the first and second layer with a strength greater than the intra-film cohesive strength of the cohesive layer. The cohesive failure leaves portions of the cohesive layer still adhered to the first and second layer. The films may further include additional layers, for example to add bulk, provide functionality, abuse resistance, printing capability or to act as a tie layer.

As used herein, the phrase “directly adhered” or “directly adhering”, as applied to film layers, is defined as adhesion of the subject film layer to the object film layer, without a tie layer, adhesive, or other layer there between.

As used herein, the term “bond-strength” refers generally to the adhesive force with which two adjacent films, or two adjacent film layers, are connected and, more specifically, to the force with which two films are connected by a heat-weld. Bond-strength can be measured by the force required to separate two films or film layers that are connected, e.g., via a heat-weld, in accordance with ASTM F88.

As used herein, the term “intra-film cohesive strength” refers to the internal force with which a film remains intact, as measured in a direction that is perpendicular to the plane of the film. In a multilayer film, intra-film cohesive strength is provided both by inter-layer adhesion (the adhesive strength between the layers which binds them to one another) and by the intra-layer cohesion of each film layer (i.e., the cohesive strength of each of the film layers). In a monolayer film, intra-film cohesive strength is provided only by the intra-layer cohesion of the layer which constitutes the film.

As used herein, the term “opening strength” refers to the amount of force required to cause intra-film cohesive failure within a layer of a multilayer film measured in accordance to the methods described herein and with ASTM F88.

All compositional percentages used herein are presented on a “by weight” basis, unless designated otherwise.

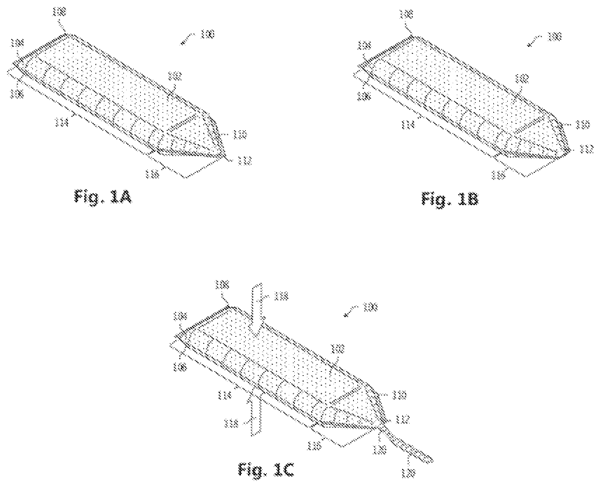

Turning now to FIGS. 1A-1C depicts a pouch 100 with a product 102 disposed therein. The pouch 100 can be any of a variety of pouches known in the art, including, for example, a stand-up pouch, a gusseted stand-up pouch, a lay-flat pouch, a pouch comprising at least one longitudinal seal, and the like. In some embodiments, the pouch 100 includes a pair of films joined together along a pair of opposing sides and a bottom bridging the sides. Alternatively, in some embodiments, the pouch 100 can be formed from a single film that has been center folded at one edge, or a pouch that includes one or more lap seals, fin seals, and/or edge seals. In another embodiment, the pouch 100 can comprise a continuous tubular material with no longitudinal seal, but with transverse seals to form transverse ends of the pouch 100. The description of pouches herein as having “first and second panels” should be understood to describe a pouch that when filled with product and laid on a surface, will display a major first surface, wall or panel, and, on the opposite side of the pouch, a second major surface, wall, or panel.

The pouch 100 includes a first panel 104 and a second panel 106 that are sealed together about the pouch perimeter with one or more perimeter seals. Perimeter seals can be formed using any suitable method, known and used in the art, such as by the use of heat, pressure, adhesive, and/or mechanical closure. In the depicted embodiment, the perimeter seals include a transverse seal 108 and a channel seal 110. The transverse seal 108 extends directly between longitudinal sides of the pouch 100 to seal one end of the pouch 100. The channel seal 110 extends indirectly between longitudinal sides of the pouch 100 to seal the other end of the pouch 100. The channel seal 110 is shaped to form a tip 112 from which the product 102 can be dispensed. The pouch 100 includes a main section 114 and a channel section 116. The main section 114 is generally the portion of the pouch 100 between the transverse seal 108 and the channel seal 110. The channel section 116 is generally the portion of the pouch 100 between the start of the channel seal 110 and the tip 112.

FIGS. 1A to 1C also depict a series of instances of a process of dispensing the product 102 from the pouch 100. In FIG. 1A, the pouch 100 is sealed closed with the product 102 disposed therein. In some embodiments, the product 102 includes a flowable product, such a condiment or a liquid. For example, in the case where the product 102 is a condiment, the condiment may be mustard, ketchup, salsa, guacamole, cheese sauce, sour cream, taco sauce, mayonnaise, tartar sauce, syrup, gravy, hot fudge, caramel, butterscotch toppings, flowable margarine or butter, horseradish, creamers, cream, yogurt, jelly, peanut butter, salad dressing, or any other type of condiment. In examples where the product 102 is a fluid, the fluid may be water, milk, lemonade, oil, or any other type of fluid.

In FIG. 1B, the tip 112 has been opened and includes a gap between portions of the first and second panels 104 and 106. Under certain conditions, the product 102 is capable of flowing out of the pouch 100 through the gap in the first and second panels 104 and 106. A cohesive layer allows for the tip to opened by applying an opening force. The cohesive layer is a type of frangible seal that opens within the cohesive layer such that the cohesive layer remains attached to both adjacent layers and a fluid channel is created within the cohesive layer. Examples of frangible seals are described in U.S. Pat. Nos. 6,983,839, 10,179,343, and U.S. Patent Application Publication No. 2006/0093765, the contents of each of which are hereby incorporated by reference in their entirety.

In FIG. 1C, pressure 118 is applied to the first and second panels 104 and 106. In some embodiments, the pressure 118 can be applied by a user manually. For example, a user can grasp the pouch 100 and squeeze the first and second panels 104 and 106 toward each other in order to apply the pressure 118. In other embodiments, the pressure 118 can be applied mechanically (e.g., by a dispenser, such as a dispenser gun that pushes on the closed end of the pouch 100), pneumatically (e.g., by increasing the gas pressure outside of the pouch 100), or in any other way. The pressure 118 applied to the pouch 100 causes the product 102 is dispensed from the tip 112 as dispensed product 120. Under some conditions, the pressure 118 is sufficient to cause the dispensed product 120 to initially exit the pouch as a stream. Once the stream of the dispensed product 120 reaches a surface (e.g., a table, a tray, a container, a food product, etc.), the dispensed product 120 can accumulate on the surface, as shown in the depicted embodiment.

The pouch 100 may be a convenient package for storing the product 102 before the product 102 is dispensed. The pouch 100 may also be convenient for a user to hold while dispensing the product 102 from the pouch 100. The pouch 100 is also capable of being used to hold and dispense products of different viscosities (e.g., viscoelastic substances, Newtonian fluids, and non-Newtonian fluids). The pouch 100 is also capable of being used to hold and dispense products that are uniform (e.g., water, ketchup, etc.) and non-uniform (e.g., tartar sauce, salsa, pickle relish, etc.).

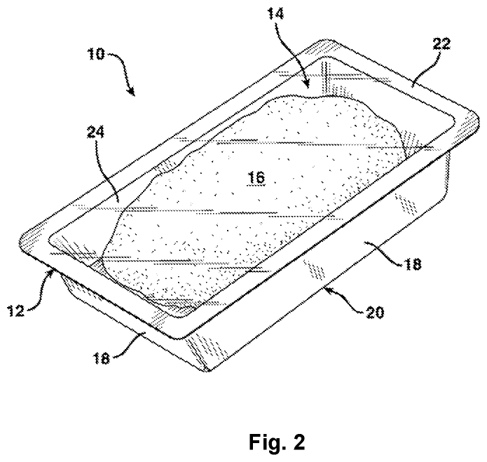

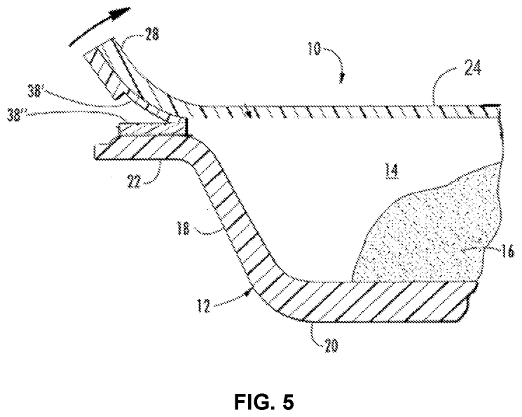

FIG. 2 illustrates a package 10 in accordance with some embodiments. The package 10 includes product support member 12 having a cavity 14 formed therein and a product 16 disposed within the cavity. In embodiments the support member 12 is in the form of a tray having side walls 18 and a base 20 which define the cavity 14, and further includes a peripheral flange 22 extending outwardly from the cavity. The support member 12 can have any desired configuration or shape, e.g., rectangular, round, oval, etc. Similarly, flange 22 may have any desired shape or design. A lid 24 encloses the product 16 within cavity 14 by being heat-welded to flange 22. The lid 24 includes a cohesive sealant layer (shown in more detail in FIG. 5) which seals the lid to the support member. The support member being predominately a polyester or polyester blend.

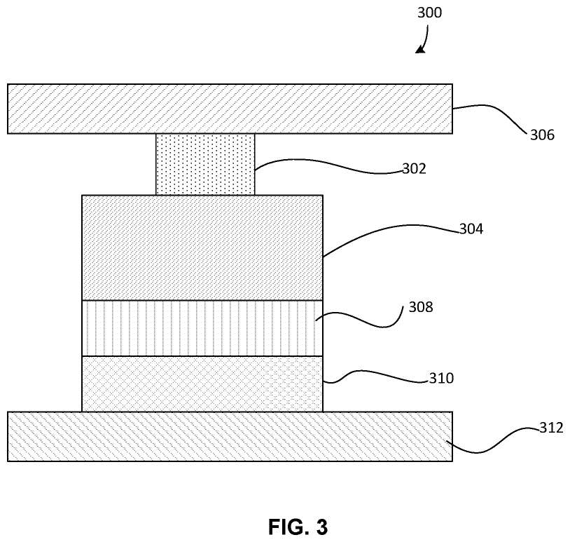

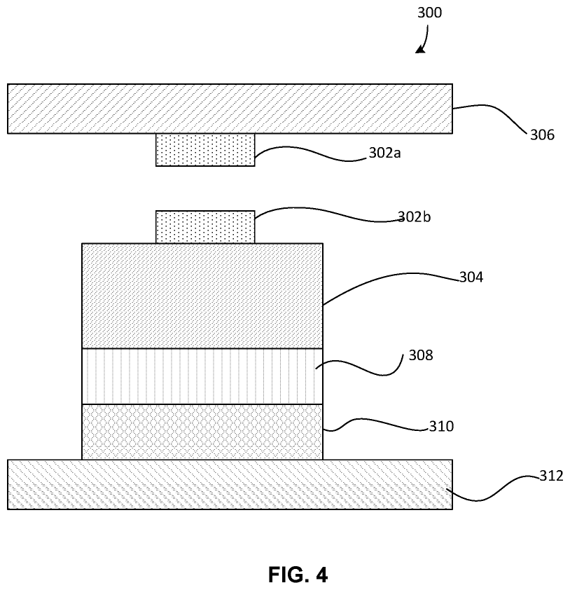

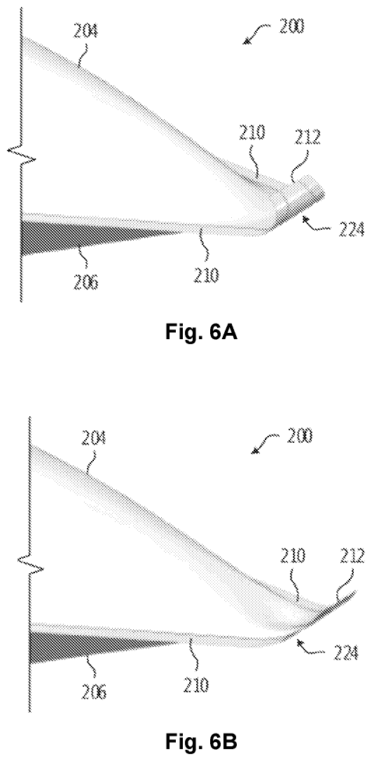

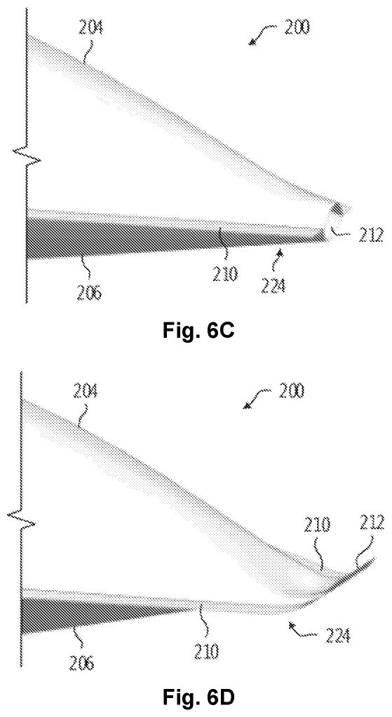

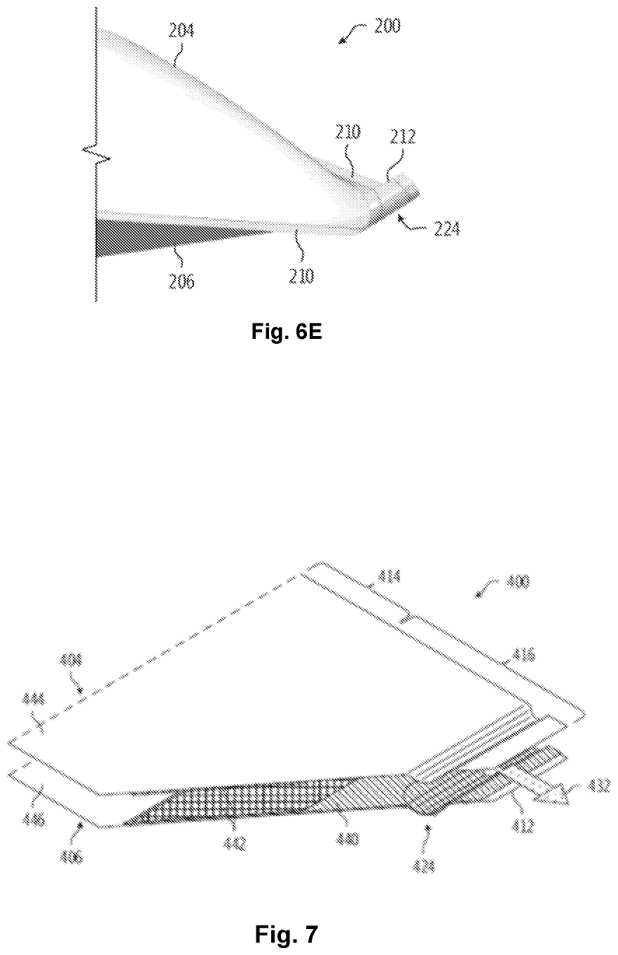

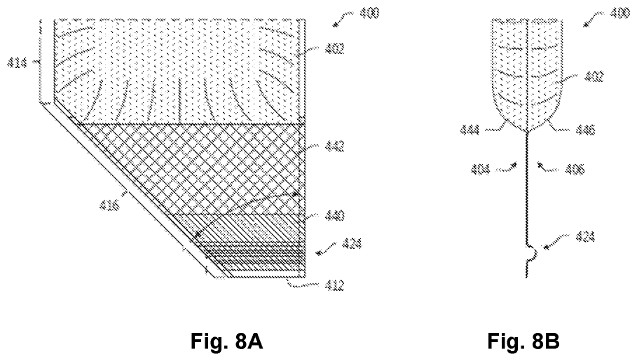

FIGS. 3-4 show a cross sectional view of a multilayer film 300 as described herein. The multilayer film includes a cohesive sealant layer 302 adhered to a first layer 304 on side and second layer 306 on the other side. In embodiments, the second layer 306 of the multilayer film 300 is the inside layer of a pouch as described herein. Additional layers such as a tie layer 308 and sealant layer 310 may be employed to bind the first layer 304 to the third layer 312. Layers 306 and 312 defining the interior surface of a pouch and being of the same composition. As a force is applied the cohesive sealant layer 302 cohesively fails and a first portion of the cohesive sealant layer 302a remains attached to the second layer 306 and a second portion of the cohesive sealant layer 302b remains attached to the first layer 304 as shown in FIG. 4. In the instance where the multilayer film 300 is formed into a pouch containing a fluid product, the first and second cohesive sealant layers 302a and 302b form a channel for the fluid to pass from the main portion to a nozzle (shown in more detail in FIGS. 6A-6D and 8A-8B. In embodiments, the first layer is a rigid or semi-rigid material predominantly comprising polyester. As used herein the term “rigid” are materials that have a modulus of elasticity either in flexure or in tension greater than 100,000 psi at 23° C. and 50% relative humidity when tested in accordance with ASTM Methods D-747 “Standard Test Method For Apparent Bending Modulus Of Plastics By Means Of A Cantilever Beam” or D-790 “Standard Test Methods For Flexural Properties Of Unreinforced And Reinforced Plastics And Electrical Insulating Materials” the contents of both which are incorporated herein by reference. As used herein the term “semi-rigid” are materials having medium modulus of elasticity either in flexure or in tension of between 10,000 and 100,000 psi at 23° C. and 50% relative humidity when tested in accordance with ASTM Methods D-747 or D-790. Since polyester layers to not generally bind well to polyethylene layers, additional layers such as tie layer 308 and sealant layer 310 are utilized to bond the insert to the layer 312. In embodiments, layers 306 and 312 define a pouch structure.

In embodiments, the first and second layers each have a bond-strength to cohesive sealant layer which is greater than the intra-film cohesive strength of cohesive sealant layer. In this manner, cohesive sealant layer delaminates within itself when applying a sufficient force. By causing cohesive failure in this fashion a fluid pathway is formed that allows for the fluid product to exit the package. The fluid contacting both portions of the cohesive sealant layer as traveling through the fluid pathway.

FIG. 5 is a cross sectional view of a portion of the tray of FIG. 2 as a force is applied to remove the lid 24. While film 28 is shown as a single structure, it is understood that the film 28 may be multilayer film with the inside layer (layer exposed to the internal space of the package) is the second layer comprising predominately polyethylene polymers as described herein. As a force is applied to the lid 24, the cohesive sealant layer 38′ and 38″ begins to cohesively fail such that that a first portion of the cohesive sealant layer 38′ remains attached to the film 28 and a second portion of the cohesive sealant layer 38″ remains attached to the flange 22 of the support member 12. The support member can be the first layer comprising predominantly polyester as described herein.

In embodiments, peeling of the film 28 is initiated by grasping and pulling the film 28 in the direction of the arrow. The pulling creates a force upwards, causing the cohesive sealant layer 38′ and 38″ to cohesively fail.

In embodiments, the product 16 is a food product. In embodiments the food product is a meat product.

Cohesive Sealant Layer

The cohesive sealant layer is directly adhered to the first and second layers. The cohesive layer comprises a blend of polymers that allow for good inter-layer bond strength to adjacent layers and a lower intra-film cohesive strength.

Inter-layer bond strength is the amount of force required to separate or delaminate two adjacent film layers by adhesive failure, as measured in accordance with ASTM F88 where the Instron tensile tester crosshead speed is 10 inches per minute, using six, 1-inch wide, representative samples. As used herein, an “adhesive failure” is a failure in which the interfacial forces (e.g., valence forces or interlocking action or both) holding two surfaces together are overcome. A “cohesive failure” is one in which the molecular attractive forces holding together a layer composition are overcome.

The blend of polymers which forms the cohesive sealant layer includes between 2-75 wt %, 35-65 wt %, 40-60 wt % or 45-55 wt % polyester; and between 5-65 wt %, 15-60 wt %, 20-55 wt % or 25-50 wt % of a compatibilizer. Useful polyesters include, but are not limited to polyethylene terephthalate, polyethylene terephthalate copolymers, amorphous polyethylene terephthalate, recycled polyethylene terephthalate, polyethylene terephthalate glycol-modified, crystallizable polyethylene terephthalate. In embodiments, the polyester is selected from polyethylene terephthalate, polyethylene terephthalate glycol-modified or blends thereof.

In embodiments, the cohesive sealant layer further includes between 5-40 wt %, 10-35 wt % or 15-30 wt % of a polyethylene polymer, or blend of polyethylene polymers. Polyethylene polymers as used herein include ethylene/alpha-olefin copolymer, polyethylene homopolymers and polyethylene copolymers.

The polyethylene polymers may be either heterogeneous or homogeneous. As is known in the art, heterogeneous polymers have a relatively wide variation in molecular weight and composition distribution. Heterogeneous polymers may be prepared with, for example, conventional Ziegler Natta catalysts.

Homogeneous polymers are typically prepared using metallocene or other single site-type catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from the Exxon Chemical Company (Baytown, Tex.) under the EXACT trademark, linear homogeneous ethylene/alpha-olefin copolymer resins available from the Mitsui Petrochemical Corporation under the TAFMER trademark, and long-chain branched, metallocene-catalyzed homogeneous ethylene/alpha-olefin copolymer resins available from the Dow Chemical Company under the AFFINITY trademark.

Homopolymer refers to a polymer resulting from the polymerization of a single monomer, i.e., a polymer consisting essentially of a single type of repeating unit. Copolymer refers to polymers formed by the polymerization reaction of at least two different monomers. For example, the term copolymer also includes terpolymers.

Polyethylene homopolymer or copolymer refers to ethylene homopolymer such as low density polyethylene; ethylene/alpha olefin copolymer such as those defined hereinbelow; and other ethylene copolymers such as ethylene/vinyl acetate copolymer; ethylene/alkyl acrylate copolymer; or ethylene/(meth)acrylic acid copolymer.

Ethylene/alpha-olefin copolymer herein refers to copolymers of ethylene with one or more comonomers selected from C4 to C12 alpha-olefins such as butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to ethylene/alpha-olefin copolymers and which high pressure polyethylenes contain both long chain and short chain branches. Ethylene/alpha-olefin copolymers include one or more of the following: 1) high density polyethylene, for example having a density greater than 0.94 g/cm³, 2) medium density polyethylene, for example having a density of from 0.93 to 0.94 g/cm³, 3) linear medium density polyethylene, for example having a density of from 0.926 to 0.94 g g/cm³, 4) low density polyethylene, for example having a density of from 0.915 to 0.939 g/cm³, 5) linear low density polyethylene, for example having a density of from 0.915 to 0.935 g/cm³, 6) very-low or ultra-low density polyethylene, for example having density below 0.915 g/cm³, and homogeneous ethylene/alpha-olefin copolymers. Homogeneous ethylene/alpha-olefin copolymers include those having a density of less than about any of the following: 0.925, 0.922, 0.92, 0.917, 0.915, 0.912, 0.91, 0.907, 0.905, 0.903, 0.90, and 0.86 g/cm³. Unless otherwise indicated, all densities herein are measured according to ASTM D1505.

Useful compatibilizers include in the context of the present disclosure are those generally useful to bind to polyester such as ethylene vinyl acetate, ethylene methyl acrylate, ionomer or ethylene butyl acrylate. It is understood that variants of the previously listed compatibilizers are contemplated, for example, maleic anhydride grafted compatibilizers. In some embodiments, the compatibilizer is ethylene vinyl acetate or ethylene methyl acrylate.

As used herein, the term “ionomer” (Io) refers to the ionized or partially ionized form of a copolymer of ethylene with a copolymerisable ethylenically unsaturated carboxylic acid monomer selected from acrylic acid and methacrylic acid wherein the neutralizing cation can be any suitable metal ion, e.g. an alkali metal ion, a zinc ion, or other multivalent metal ions.

In embodiments the cohesive sealant layer has an opening strength of between 0.4 and 3.4 lb-f/in or between 0.9 and 3.0 lb-f/in measured according to ASTM F88 with a crosshead speed of 10 inches per minute, using a 1-inch wide sample. In other embodiments the cohesive sealant layer has an opening strength of at least 0.9 lb-f/in measured according to ASTM F88 with a crosshead speed of 10 inches per minute, using a 1-inch wide sample. In other embodiments the cohesive sealant layer has an opening strength of at not more than 1.6 lb-f/in measured according to ASTM F88 with a crosshead speed of 10 inches per minute, using a 1-inch wide sample. The cohesive sealant layer has a bond strength to adjacent layers that is greater than the opening strength resulting in in a continuous portion of the cohesive sealant layer remaining bonded to both adjacent layers when subjected to a force greater than the opening strength.

The thickness of the cohesive sealant layer may be selected to provide sufficient material result in a strong seal bond and to provide good peelability, yet not so thick so as to negatively affect the characteristics of the film to an unacceptable level. The cohesive sealant layer may have a thickness of at least any of the following values: 0.3 mils, 0.35 mils, 0.4 mils, 0.45 mils, 0.5 mils, and 0.6 mils. The cohesive sealant layer may have a thickness less than any of the following values: 5 mils, 4 mils, 3 mils, 2 mils, 1 mil, 0.7 mils, 0.5 mils, and 0.3 mils. The thickness of the cohesive sealant layer as a percentage of the total thickness of the film may be less that any of the following values: 50%, 40%, 30%, 25%, 20%, 15%, 10%, and 5%; and may range between any of the forgoing values (e.g., from 10% to 30%).

First Layer

The first layer which is adhered to the cohesive sealant layer is predominately a polyester. The first layer may be a rigid or semi-rigid tray, a rigid or semi-rigid insert a flexible film or a support member such as a tray. In embodiments, the first layer comprises at least 90 wt %, 92 wt %, 94 wt %, 96 wt %, 98 wt %, or greater than 99 wt % of a polyester.

Polyesters are polymers obtained by the polycondensation reaction of dicarboxylic acids with dihydroxy alcohols. Suitable dicarboxylic acids are, for instance, terephthalic acid, isophthalic acid, 2,6-naphthalene dicarboxylic acid and the like. Suitable dihydroxy alcohols are for instance ethylene glycol, diethylene glycol, 1,4-butanediol, 1,4-cyclohexanedimethanol and the like. Examples of useful polyesters include poly(ethylene 2,6-naphtalate), poly(ethylene terephthalate), and copolyesters obtained by reacting one or more dicarboxylic acids with one or more dihydroxy alcohols, such as polyethylene terephthalate glycol which is an amorphous co-polyesters of terephthalic acid with ethylene glycol and 1,4-cyclohexanedimethanol.

Useful polyesters include, but are not limited to polyethylene terephthalate, polyethylene terephthalate copolymers, amorphous polyethylene terephthalate, recycled polyethylene terephthalate, polyethylene terephthalate glycol-modified, crystallizable polyethylene terephthalate. In embodiments, the polyester is selected from polyethylene terephthalate, polyethylene terephthalate glycol-modified or blends thereof.

The thickness of the first layer may be selected to provide sufficient rigidity to the film structure or to support a product, but not so thick as to negatively affect the characteristics of the film to an unacceptable level. The first layer may have a thickness of at least any of the following values: 0.3 mils, 0.35 mils, 0.4 mils, 0.45 mils, 0.5 mils, and 0.6 mils. The first layer may have a thickness less than any of the following values: 25 mils, 20 mils, 15 mils, 14 mils, 13 mils, 12 mils, 11 mils, 10 mils, 9 mils, 8 mils, 7 mils, 6 mils, 5 mils, 4 mils, 3 mils, 2 mils, 1 mil, 0.7 mils, 0.5 mils, and 0.3 mils. The thickness of the first layer as a percentage of the total thickness of the film may be less that any of the following values: 80%, 70%, 60%, 50%, 40%, 30%, 25%, 20%, 15%, 10%, and 5%; and may range between any of the forgoing values (e.g., from 10% to 30%).

The first layer may be part of a multilayer structure such as depicted in FIGS. 2-3. In other embodiments, the first layer is a tray or part of a tray. Trays are useful for supporting products therein. In yet other embodiments, the first layer is flexible film, or part of a flexible film.

Second Layer

The second layer which is adhered to the cohesive sealant layer is predominately a polyethylene polymer. Polyethylene polymers do not seal well to polyester and therefore an intermediate layer is needed to create an effective seal. In embodiments, the second layer is a flexible film or a layer in a multilayer film. In embodiments, the first layer comprises at least 90 wt %, 92 wt %, 94 wt %, 96 wt %, 98 wt %, or over 99 wt % of a polyethylene polymer as described herein.

In embodiments, the polyethylene polymer is a high density polyethylene, medium density polyethylene, linear medium density polyethylene, low density polyethylene, linear low density polyethylene, or very-low or ultra-low density polyethylene.

In embodiments, the second layer is flexible film. The flexible film may be a monolayer or multilayer film so long as an outside layer of the flexible film is predominately a polyethylene polymer as described herein. In an embodiment, the flexible film forms a pouch with the second layer defining the pouch or the inner portion of the pouch.

The second layer may include one or more additives useful in packaging films, such as, antiblocking agents, slip agents, antifog agents, colorants, pigments, dyes, flavorants, antimicrobial agents, meat preservatives, antioxidants, fillers, radiation stabilizers, and antistatic agents. Such additives, and their effective amounts, are known in the art.

The second layer may have a thickness of at least any of the following values: 0.3 mils, 0.35 mils, 0.4 mils, 0.45 mils, 0.5 mils, and 0.6 mils. The second layer may have a thickness less than any of the following values: 5 mils, 4 mils, 3 mils, 2 mils, 1 mil, 0.7 mils, 0.5 mils, and 0.3 mils. The thickness of the second layer as a percentage of the total thickness of the film may be less that any of the following values: 50%, 40%, 30%, 25%, 20%, 15%, 10%, and 5%; and may range between any of the forgoing values (e.g., from 10% to 30%).

Additional Layers of the Film

The multilayer film may include one or more additional layers, such as a tie, core, or bulk layers. A tie layer is an inner film layer having the primary purpose of adhering two layers of a film together.

A core or bulk layer may be an inner film layer having a primary purpose other than as a barrier or tie layer—for example, serving to provide a multilayer film with a desired level of strength, modulus, or optics.

One or more layers of the films may include one or more additives useful in packaging films, such as, antiblocking agents, slip agents, antifog agents, colorants, pigments, dyes, flavorants, antimicrobial agents, meat preservatives, antioxidants, fillers, radiation stabilizers, and antistatic agents. Such additives, and their effective amounts, are known in the art.

One or more of the layers of the films—or at least a portion—may be cross-linked to improve the strength of the film, improve the orientation of the film, and help to avoid burn through during heat seal operations. Cross-linking may be achieved by using chemical additives or by subjecting one or more film layers to one or more energetic radiation treatments-such as ultraviolet, X-ray, gamma ray, beta ray, and high energy electron beam treatment—to induce cross-linking between molecules of the irradiated material. Useful radiation dosages include at least about any of the following: 5, 7, 10, 15, 20, 25, 30, 35, 40, 45, and 50 kGy (kiloGrey). Useful radiation dosages include less than about any of the following: 130, 120, 110, 100, 90, 80, and 70 kGy (kiloGrey). Useful radiation dosages include any of the following ranges: from 5 to 150, from 10 to 130, from 5 to 100, and from 5 to 75 kGy.

All or a portion of one or two surfaces the film may be corona and/or plasma treated to change the surface energy of the film, for example, to increase the ability to print or laminate the film. One type of oxidative surface treatment involves bringing the sealant film into the proximity of an O2- or N2-containing gas (e.g., ambient air) which has been ionized. Exemplary techniques are described in, for example, U.S. Pat. No. 4,120,716 (Bonet) and U.S. Pat. No. 4,879,430 (Hoffman), which are incorporated herein in their entirety by reference. The film may be treated to have a surface energy of at least about 0.034 J/m2, at least about 0.036 J/m2, at least about 0.038 J/m2, and at least about 0.040 J/m2.

The film may each be separately manufactured by thermoplastic film-forming processes known in the art (e.g., tubular or blown-film extrusion, coextrusion, extrusion coating, flat or cast film extrusion). A combination of these processes may also be employed.

The resulting inter-layer bond strength between the cohesive sealant layer and the first and second layers is sufficiently strong to withstand the expected use conditions. For example, the inter-layer bond strength must be greater than the intra-film cohesive strength of the cohesive sealant layer. In embodiments the cohesive sealant layer has an intra-film cohesive strength of not more than 90%, 80%, 70%, 60%, 50%, 40%, 30%, 20% or 10% of the bond strength of the cohesive sealant layer to both of the first and second layer as measured in accordance with ASTM F88 where the Instron tensile tester crosshead speed is 10 inches per minute and a 1-inch wide sample.

The weakest point of any of the inter-layer bond strength between adjacent layers and the intra-layer cohesive strength of the layers is located within the cohesive sealant layer.

In embodiments, the multilayer film is non-oriented. The term “non-oriented: refers to films that had not been subjected to any orientation process, also known as “cast films”.

As used herein the term “orientation process” relates to stretching the coextruded tape or tube in at least one or in two perpendicular directions, typically the longitudinal or machine direction (MD) and the transverse or crosswise direction (TD), at a temperature higher than the highest Tg of the resins making up the film layers and lower than the highest melting point of at least one polymer of the film layers, namely at a temperature where the resins, or at least some of the resins, are not in the molten state.

In embodiments, the multilayer film is a non-oriented, non heat-shrinkable film. Such films have not been oriented by stretching under temperature conditions, as indicated above. Upon subsequent reheating, the non-oriented, non heat-shrinkable film will not or will minimally shrink in seeking to recover its original dimensional state as an oriented, heat-shrinkable film does.

In embodiments, the multilayer film is non heat-shrinkable. As used herein “non heat-shrinkable” refers to a film having a free shrink percentage (as measured by ASTM D 2732, at 95° C.) in both the machine and transverse directions of less than 15%, less than 10% or less than 5%. As used herein, the phrases “heat-shrinkable,” “heat-shrink,” and the like, refer to the tendency of the film to shrink upon the application of heat, i.e., to contract upon being heated, such that the size of the film decreases while the film is in an unrestrained state. As used herein said term refer to films with a free shrink in each of the machine and the transverse directions, as measured by ASTM D 2732, of at least 5% at 95° C.

Fluid Dispensing Device

In an embodiment as depicted in FIGS. 6A to 6E, the multilayer structure includes a pouch 200 having a valve that resists product leakage and is self-closing. More specifically, FIGS. 6A to 6E depict a process of dispensing product from the pouch 200 and also the front perspective views of the tip of the pouch 200 alone (e.g., without the product shown).

The pouch 200 has a product (not shown) disposed therein. The pouch 200 includes a first panel 204 and a second panel 206 that are sealed together about the pouch perimeter with one or more perimeter seals. While the first panel 204 and second panel 206 are depicted as distinct panels, it is understood that a single film can be used to construct the pouch 200 with a single perimeter seal, end seal, side seal or could be formed from tubing. In the depicted embodiment, the perimeter seals include a channel seal 210. The channel seal 210 is shaped to form a tip 212 from which the product can be dispensed. The tip 212 may be centered as depicted, off set, adjacent to an end of the pouch.

The channel section of the pouch 200 includes a valve 224 with an insert (shown in more detail in FIG. 7) disposed therein. In some embodiments, the valve 224 extends transversely across the channel section such that the product flows through the valve 224 in order to pass from the main section of the pouch 200 to the tip 212 of the pouch 200. In some embodiments, the valve 224 extends substantially perpendicular to the flow of the product and/or substantially parallel to the tip 212 of the pouch 200. In other embodiments, the valve 224 extends transversely across the channel section (e.g., from one side of the channel section to the other side of the channel section) along a path that is neither perpendicular to the flow of the product nor parallel to the tip 212 of the pouch 200. In embodiments, the valve 224 has a curve that can be any type of crimp, crease, inflection, kink, or other form of a curve in the first and second panels 204 and 206. The cross-section of the valve 224 can be uniformly round (e.g., a semi-cylindrical crimp), can have a curvature of varying diameters (e.g., a non-uniform curvature), or have any other curved shape. In some embodiments, when the pouch 200 is in a resting state (e.g., no external forces are applied to the pouch 200), the valve 224 collapses the channel section of the pouch 200 to deter flow of the product through the valve 224.

In the first instance shown in FIG. 6A, the pouch 200 is in a resting state. In some embodiments, a pouch is in a resting state when no external forces (e.g., no forces other than natural forces, such as gravity, ambient air pressure, and the like) are applied to the pouch. In the resting state, the valve 224 in the channel section of the pouch 200 is curved such that the valve 224 deters flow of the product through the valve 224. In some embodiments, the valve 224 collapses the channel to prevent flow of the product through the valve 224 when the pouch 200 is in the resting state. In this condition, the product does not flow or leak out of the tip 212.

In the second instance shown in FIG. 6B, a user begins to exert a force on the pouch 200 (such as by squeezing) to exert an external force on the exterior of the first and second panels 204 and 206 of the pouch 200. As the user increases the external force on the pouch 200, the valve 224 begins to straighten. However, in this second instance, the pressure induced in the product by the external force applied by the user is insufficient to cause the valve 224 to open (e.g., to open completely). Thus, in the second instance, the product is still not being dispensed from or leaking from the tip 212. In some embodiments, the first panel 204 is less rigid than the second panel 206 at the valve 224. Where the first panel 204 is less rigid than the second panel 206 at the valve 224, the second panel 206 may resist the straightening of the valve 224 due to the increased pressure. This resistance by the second panel 206 increases the ability of the user to control when the product is able to flow through the valve 224. The insert may impart the additional rigidity. In other embodiment the film of the second panel 206 can have a greater thickness and/or a higher modulus of elasticity than the film of the first panel 204.

In the third instance shown in FIG. 6C, the user continues to squeeze the pouch 200. In this instance, the user is exerting sufficient external force to induce a pressure in the product that straightens the valve 224 at least partially open the valve 224. With the valve 224 open, the product can flow through the valve 224 and be dispensed from the tip 212 as dispensed product 220. In the depicted embodiment, the dispensed product 220 initially exits the tip 212 of the pouch 200 as a stream. Once the stream of the dispensed product 220 reaches a surface (e.g., a counter, a container, a food product, etc.), the dispensed product 220 accumulates on the surface. In embodiments where the user moves the pouch 200 while the product is being dispensing, the product 220 can accumulate on the surface in lines, curves, or any other shape based on the movements of the pouch 200 by the user. As can be seen in FIG. 6C, the tip 212 of the pouch 200 in the depicted embodiment forms a rounded shape (e.g., oval shape or circle shape). The round shape of the tip 212 allows products that include particulates (e.g., tartar sauce, salsa, pickle relish, etc.) to be dispensed from the tip 212. In the depicted embodiment, as the product flows through the curve of the valve 224, the product flows by a convex side of the first panel 204 in the curve and a concave side of the second panel 206 in the curve.

In the fourth instance depicted in FIG. 6D, the user has reduced the amount of external force applied to the pouch 200 until the pressure induced in the product is no longer sufficient to prevent the valve 224 from closing. As the valve 224 retracts, the valve 224 prevents the product from flowing through the valve 224. The product is no longer dispensed from the tip 212 and the product does not leak from the tip 212. In some embodiments, where the first panel 204 is less rigid than the second panel 206 at the valve 224, the second panel 206 may cause the tube shape of the channel section to collapse when the user reduces the amount of external force applied to the pouch 200. This collapsing of the tube shape caused by the second panel 206 as a result of the reduced external force can cause the flow of product through the valve 224 to cease before the valve 224 fully reaches its resting state. This collapsing action significantly reduces the possibility of inadvertent dispensing and/or leaking of the product after the user stops dispensing the product. Examples of pouches where the first panel is less rigid than the second panel at the valve are described in greater detail below.

In the fifth instance shown in FIG. 6E, the pouch 200 has returned to the resting state with the user no longer exerting an external pressure on the pouch 200. In the resting state, the valve 224 in the channel section of the pouch 200 is curved such that the valve 224 deters flow of the product through the valve 224. In some embodiments, the valve 224 collapses the channel to prevent flow of the product through the valve 224 when the pouch 200 is in the resting state. In this condition, the product does not flow or leak out of the tip 212.

In the series of the first to fifth instances shown in FIGS. 6A to 6E, the ability of the pouch 200 to dispense the product when desired and to prevent flow of the product when dispensing is not desired depends on the operation of the valve 224. In particular, it may be desirable for the valve 224 to function so that the valve 224 permits the product to flow when the user intends to dispense the product and so that the valve 224 does not permit the product to flow when the user does not intend to dispense the product. For example, when the user exerts a force on the pouch 200 that exceeds a threshold amount, the valve 224 should react by opening at least partially to permit the product to flow to the tip 212. Similarly, when the user exerts a force on the pouch 200 that does exceed the threshold amount and/or when the user does not exert a force on the pouch 200, the valve 224 could react by closing to a position where the channel is collapsed and the product is not able to flow to the tip 212.

For the product to be dispensed from the pouch 200, the pressure induced in the product by an external force will exceed a threshold that causes the curve in the valve 224 to straighten at least partially. A number of variables impact the ease or difficulty to sufficiently straighten the valve 224. Among those variables are the modulus of the films, the rigidity of the insert, the diameter of the curve of the valve 224, and the thickness of the material of the film(s).

Turning now to FIG. 7, a pouch 400 shown. The pouch is shown as being two panels, but other methods of making the pouch (such as by end seal, side seal, tubing) are envisioned. The first panel 404 includes the film 444 and the second panel 406 includes the film 446 and an insert 440. In embodiments, the insert 440 is located in the nozzle portion 416. The pouch 400 also includes a cohesive sealant layer 442 which is bonded to the insert 440 on one side and the inner surface of the film 444 on the other. In some embodiments, the cohesive sealant layer 442 is located between the main section 414 and the valve 424. In the exploded view shown in FIG. 7, the inner faces of the panels 404 and 406 are separated from each other; however, the inner faces of the panels 404 and 406 may not otherwise be separated from each other. Before the first dispensing of the product from the pouch 400, the cohesive sealant layer 442 as to prevent the product disposed in the main section 414 from flowing to the valve 424. The cohesive sealant layer has an intra-layer cohesive bond strength such that a user can break the seal by exerting an external force on the pouch to induce a pressure in the product that exceeds the seal strength of the cohesive sealant layer 442. Once the cohesive sealant layer 442 fails, the product can flow from the tip 412 in the direction of the arrow 432.

Depicted in FIGS. 8A and 8B are front and side views, respectively, of the embodiment of the pouch 400 shown in FIG. 7 with a product 402 disposed in the main section 414. In the embodiment depicted, the cohesive sealant layer 442 has not yet been broken (e.g., before the first dispensing of the product 402 from the pouch 400) and the cohesive sealant layer 442 is preventing the product 402 from flowing to the valve 424. While the valve 424 is shown as being curved, in embodiments the valve has a different radius or no radius. For example, a larger radius may span the majority of the nozzle portion 416. Once the cohesive sealant layer 442 fails the cohesive sealant layer remains attached to the two adjacent surfaces created a fluid channel for the product 402 to flow to the valve 424 and out the tip 412.

Method

A method of making a multilayer package from the multilayer film is contemplated. In embodiments, the method includes i) providing a first layer comprising predominately polyester ii) providing a second layer comprising predominately polyethylene polymers iii) providing a multilayer film comprising a cohesive sealant layer and one of the first layer or the second layer; and iv) heat sealing the cohesive sealant layer to the other of the first layer or the second layer that is not part of the multilayer film. The cohesive sealant layer comprises between 35-65 wt % polyester; and between any of 5-75 wt % or 10-65 wt % compatibilizer. The cohesive sealant layer has an opening strength of between 0.4 and 3.4 lb-f/in or between 0.9 and 3.0 lb-f/in measured according to ASTM F88 with a crosshead speed of 10 inches per minute, using a 1-inch wide sample and the cohesive sealant layer has a bond strength to both of the first and second layer which is greater than the opening strength resulting in in a continuous portion of the cohesive sealant layer remaining adhered to both the first layer and the second layer when subjected to a force greater than the opening strength.

### Examples

The following examples are presented for the purpose of further illustrating and explaining the present invention and are not to be taken as limiting in any regard.

In the comparatives and examples below, the following materials were used:

PETG1 is polyethylene terephthalate glycol-modified.

PETG2 is polyethylene terephthalate glycol-modified.

PE1 is a linear low density ethylene/hexene copolymer.

PE2 is a commercially available film having an enhanced sealant layer sold by Sealed Air under the trade name FS5535.

EVA1 is an ethylene/vinyl acetate copolymer having a vinyl acetate content of more than 20%.

EVA2 is an ethylene/vinyl acetate copolymer having a vinyl acetate content of less than 10%

Blends of the materials were mixed and dried prior to cast extrusion to create the films having a thickness of approximately 2 mils as shown in Table 1 below. The films being a two-layer film with one layer being the blend recited in Table 1 and the second layer being a polyethylene terephthalate glycol-modified layer (PETG2). After about 1 week, the films were sealed to PE2 in the following manner. The seal was made along the transverse directions of both the film made from blend and PE2. A seal bar was applied to seal the two films together with a pressure of 50 psi at heat of 320° F. for 0.6 s.

Six samples were prepared for each blend. After at least 24 hours, each sample was pulled in a peel arrangement using an Instron tensile tester with a crosshead speed of 10 inches per minute. The maximum amount of force required to cause a cohesive or adhesive failure either within laminate that was sealed to the support member or in the bond between the laminate and the support member was measured in accordance with ASTM F88. The results were averaged for each set of six sample and are shown in Tables 1 and 2 below.

TABLE 1

| | | | | Force | Std | Seal failure |
|---|---|---|---|---|---|---|
| Blend # | PETG1 | PE1 | EVA1 | (lb/in) | Dev | type |
| 1 | 25 | 20 | 55 | 2.836 | 0.129 | Mostly Cohesive |
| 2 (C) | 25 | 55 | 20 | 2.464 | 0.151 | Delamination |
| | | | | | | failure |
| 3 | 35 | 5 | 60 | 1.913 | 0.129 | Cohesive |
| 4 | 35 | 35 | 30 | 1.364 | 0.195 | Cohesive |
| 5 | 40 | 0 | 60 | 1.654 | 0.28 | Cohesive |
| 6 | 40 | 60 | 0 | 2.253 | 0.279 | Mostly Cohesive |
| 7 | 55 | 5 | 40 | 0.418 | 0.031 | Mostly Cohesive |
| 8 | 55 | 25 | 20 | 0.366 | 0.042 | Mostly Cohesive |
| 9 (C) | 65 | 10 | 25 | 0.153 | 0.027 | Adhesive failure |
| 10 | 65 | 25 | 10 | 0.238 | 0.047 | Mostly Cohesive |
| 11 | 45 | 5 | 50 | 1.421 | 0.1 | Cohesive |
| 12 | 45 | 25 | 30 | 0.968 | 0.051 | Cohesive |
| 13 | 45 | 55 | 0 | 2.858 | 0.937 | Mostly Cohesive |
| 14 | 50 | 5 | 45 | 0.981 | 0.042 | Cohesive |
| 15 | 50 | 25 | 25 | 0.618 | 0.037 | Mostly Cohesive |
| 16 | 55 | 45 | 0 | 1.042 | 0.167 | Cohesive |

TABLE 2

| | | | | Force | Std | Seal failure |
|---|---|---|---|---|---|---|
| Blend # | PETG1 | PE1 | EVA2 | (lb/in) | Dev | type |
| 17 (C) | 65 | 15 | 20 | 0.16 | 0.016 | Adhesive failure |
| 18 | 25 | 15 | 60 | 2.416 | 0.39 | Nearly Cohesive |
| | | | | | | with some |
| | | | | | | delamination |
| 19 | 55 | 15 | 30 | 0.365 | 0.04 | Nearly Cohesive |

As seen in Tables 1 and 2 above, films created within the specific range of materials resulted in a good cohesive failure within the layer made from the blend. Blend 2 has a delamination failure as the blend to do not bind well to the PETG2 layer. Blend 9 did not have a good adhesive seal to the PE2 layer and therefore had an adhesive failure before the layer made from the blend could cohesively fail.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A multilayer package comprising:
a. a first layer comprising predominately polyester;
b. a second layer comprising predominately polyethylene polymers; and
c. a cohesive sealant layer directly adhered to both the first and second layers, the sealant layer comprising:
i. between 35-65 wt % polyester; and
ii. between 5-65 wt % compatibilizer;
wherein the cohesive sealant layer has an opening strength of between 0.4 and 3.4 lb-f/in measured according to ASTM F88 with a crosshead speed of 10 inches per minute, using a 1-inch wide sample and the cohesive sealant layer has a bond strength to both of the first and second layer which is greater than the opening strength resulting in in a continuous portion of the cohesive sealant layer remaining adhered to both the first layer and the second layer when subjected to a force greater than the opening strength.

2. The multilayer package of claim 1 wherein the cohesive sealant layer further comprises between 5-40 wt % of polyethylene polymers.

3. The multilayer package of claim 1 wherein the polyester of the first layer and the polyester of the cohesive sealant layer is selected from polyethylene terephthalate, polyethylene terephthalate glycol-modified or blends thereof.

4. The multilayer package of claim 1 wherein the cohesive sealant layer has an intra-film cohesive strength of not more than 90%, 80%, 70%, 60%, 50%, 40%, 30%, 20% or 10% of the bond strength of the cohesive sealant layer to both of the first and second layer.

5. The multilayer package of claim 1 wherein the compatibilizer is ethylene vinyl acetate, ethylene methyl acrylate or blends thereof.

6. The multilayer package of claim 1 wherein the polyester of the first layer comprises at least 90 wt %, 92 wt %, 94 wt %, 96 wt %, 98 wt %, or over 99 wt % of a polyester is selected from the group consisting of polyethylene terephthalate, polyethylene terephthalate glycol-modified and blends thereof.

7. The multilayer package of claim 1 wherein the polyethylene of the second layer comprises predominantly a linear low density polyethylene.

8. The multilayer package of claim 1 wherein the polyethylene of the cohesive sealant layer is a linear low density polyethylene.

9. The multilayer package of claim 1 wherein the second layer is rigid or semi-rigid.

10. The multilayer package of claim 9 wherein the second layer is a rigid or semi-rigid tray.

11. The multilayer package of claim 1 wherein the first layer is flexible.

12. The multilayer package claim 1 further comprising a fluid sealed within the package.

13. The multilayer package of claim 1, further comprising a fluid sealed within the package and when subjecting the package to a force greater than the opening strength, a fluid pathway is created within the cohesive sealant layer allowing for the fluid to exit the package through the fluid pathway.

14. The multilayer package of claim 1 wherein the first and second layers are in contact with each other along a first portion of a surface of the second layer and separated by the cohesive sealant layer along a second portion of the surface of the second layer.

15. A multilayer structure comprising:
a. a flexible film comprising an inner layer comprising predominately polyethylene polymers;
b. a rigid or semi-rigid insert comprising a layer comprising predominately polyester
c. a cohesive sealant layer having two sides which are direct adhered to the inner layer of the flexible film on one side and direct adhered to the layer comprising predominately polyester of the rigid or semi-rigid insert on the other side; the cohesive sealant layer comprising:
i. between 25-65 wt % polyester; and
ii. between 5-65 wt % compatibilizer;
wherein the cohesive sealant layer has an opening strength of between 0.4 and 3.4 lb-f/in measured according to ASTM F88 with a crosshead speed of 10 inches per minute, using a 1-inch wide sample and the cohesive sealant layer has a bond strength to both of the inner layer of the flexible film and the layer comprising predominately polyester of the rigid or semi-rigid insert which is greater than the opening strength resulting in in a continuous portion of the cohesive sealant layer remaining adhered to both the inner layer of the flexible film and the layer comprising predominately polyester of the rigid or semi-rigid insert when subjected to a force greater than the opening strength.

16. The multilayer structure of claim 15 wherein the rigid or semi-rigid insert is a multilayer structure further comprising a layer comprising predominately polyethylene polymers.

17. The multilayer structure of claim 16 wherein the flexible film forms a pouch having a tip and the rigid or semi-rigid insert is positioned proximal the tip.

18. The multilayer structure of claim 17 wherein the layer comprising predominately polyethylene polymers of the rigid or semi-rigid is directly adhered to a portion of the inner layer of the flexible film.

19. (canceled)

20. The multilayer structure of claim 19 wherein the cohesive sealant layer has an opening strength of less than 2.0 lb-f/in measured according to ASTM F88.

21-28. (canceled)

29. A method of making a multilayer package comprising the steps of:
a. providing a first layer comprising predominately polyester;
b. providing a second layer comprising predominately polyethylene polymers; and
c. providing a multilayer film comprising a cohesive sealant layer and one of the first layer or the second layer;
d. heat sealing the cohesive sealant layer to the other of the first layer or the second layer that is not part of the multilayer film;
i. the cohesive sealant layer comprising:
between 35-65 wt % polyester; and
between 5-65 wt % compatibilizer;
wherein the cohesive sealant layer has an opening strength of between 0.4 and 3.4 lb-f/in measured according to ASTM F88 with a crosshead speed of 10 inches per minute, using a 1-inch wide sample and the cohesive sealant layer has a bond strength to both of the first and second layer which is greater than the opening strength resulting in in a continuous portion of the cohesive sealant layer remaining adhered to both the first layer and the second layer when subjected to a force greater than the opening strength.

30-40. (canceled)
